(19) United States
(12) Patent Application Publication
(10) Pub. No.: US 2006/0258418 A1
(43) Pub. Date: Nov. 16, 2006

(54) Specific numeric values sort with image retrieval & reproduction method

(76) Inventor: Yu-le Lin, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/411,778

(22) Filed: Apr. 27, 2006

(30) Foreign Application Priority Data
May 13, 2005 (TW) 094115465

(51) Int. Cl. A63F 13/00

(52) U.S. Cl. 463/1

(57) ABSTRACT

A method to incorporate specific numeric values queue with image retrieval and reproduction includes sort and generating a result; image being retrieved and stored once the result meets preset condition; and in the course of sorting, image retrieved being present at the same time corresponding to the result on a display unit for making sorting process more fun and lively.

### BACKGROUND OF THE INVENTION

(a) Field of the Invention

The present invention relates to a method to present sort in a display unit, and more particularly, to one that incorporates sort with voluntary retrieval of image contents.

(b) Description of the Prior Art

Data in a digital database usually are sorted before being present in a display unit to facilitate reading, compiling statistics, tabulating, or comparing results of a competition. For example, test scores, sales records, annual performance, or game results are generally present in sorted order. At present the common sorting method is present either in numeric value or word for the viewer to fast read specific records, such as that of the highest scores achieved or the top five places of achievement reports by following the sorting method. However, the presentation by numeric value or word though facilitates fast reading out but lacks in the function to highlight the specific records. That is, the prior art fails to create effects of “entertaining”, “incentives”, or “giving distinguishing feature”. In term of a competition, the prior art of sorting practically doe not help the competition create any additional features and the user is very difficult to develop strong desire of being named in the list of name posted. The reason is that in the sorting results of achievement report, e.g., the billboard of scores, letters (possibly in the form of name or code) are the only symbol to represent one listed; therefore, it is absolutely deprived of addressing personal feature to fail satisfying the one listed.

### SUMMARY OF THE INVENTION

The primary purpose of the present invention is to provide a sorting method with self-definition feature to make the sorting process more fun and lively while solving the problems found with the prior art.

To achieve the purpose, the present invention is a method to incorporate a specific sort of numeric values with image retrieval and reproduction comprising the following steps:

A. Set up condition;

B. Perform a specific procedure to generate a result;

C. Procedure of retrieving an object is activated if and when the result complies with the preset condition;

D. The object retrieved is stored and have the object retrieved corresponding to the results availed in Step B;

E. When multiple result availed in Step B are present, the object retrieved is present accompanied by its corresponding result.

Preferably the object referred in the procedure to activate retrieving the object in Step C is a stationary image, dynamic image, or a voice or any combination of them.

Preferably the object retrieved as described in Step E is present in its original form in Step E.

Preferably the object retrieved as described in Step E for having been processed is not present in its original form.

Preferably the object retrieved and processed can only be present together with its corresponding result under certain conditions.

The present invention further relates to an installation to execute the method disclosed in the present invention including a portable game, PDA, computer, game installation, or camera.

The present invention further relates to a medium programmed to execute the method disclosed in the present invention that can be read by a computer.

The present invention provides the following advantages:
1. The sorting recorded is incorporated with image to make the sorting method more versatile.
2. The operator may retrieve the image as desired to create personal style.
3. The image may be processed before being present to particularly manifest certain records.
4. The user is motivated to develop stronger desire of being listed in case that the sorting is related to a billboard.
5. The function of image retrieval is opened under certain conditions to become a factor of incentives to the user.
6. Incorporation with image helps the viewer develop profound impression of specific records in the sorting results.

### BRIEF DESCRIPTION OF THE DRAWINGS

FIG. 1 is a flow chart showing the method of the present invention.

FIG. 2 is a schematic view showing an application of the present invention in a mobile phone.

### DETAILED DESCRIPTION OF THE PREFERRED EMBODIMENTS

The present invention related to a method to incorporate specific numeric values sort with image retrieval and reproduction is applicable to the sorting of records stored in a digital database. The present invention is described using a preferred embodiment comprised of scores sorted in game software of a portable installation, i.e., a mobile phone, adapted with a camera lens.

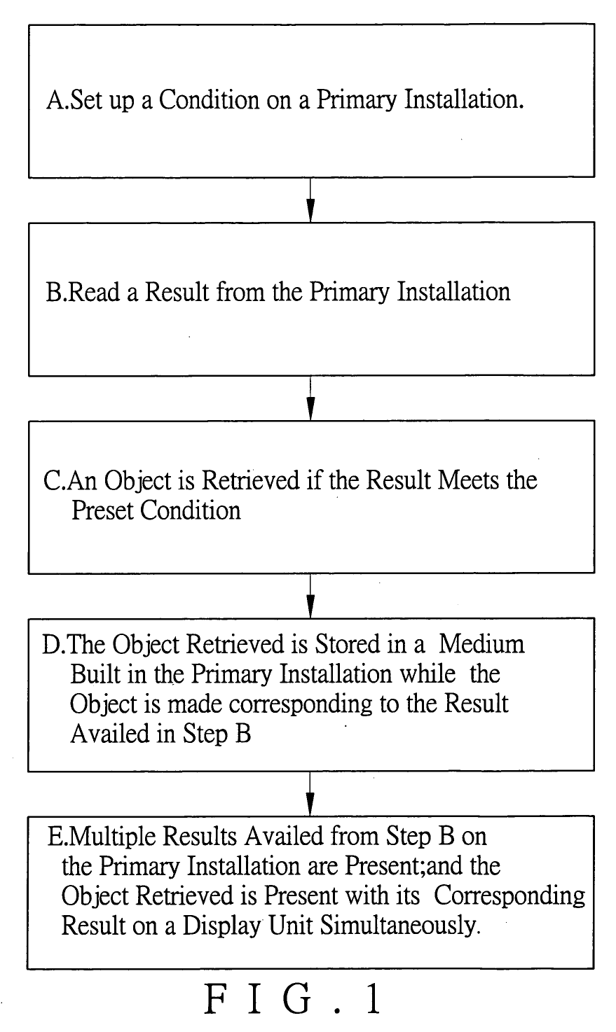

Referring to FIG. 1, the present invention comprises the following steps:
A. Set up condition.
   The primary installation is a mobile phone installed with game software; scores are given depending on the result of each time the game software is executed; and in the present invention, the qualification is defined as “the scores must be ranked at top five of the billboard”.
B. Perform a specific procedure to generate a result.
   The game software is executed to generate a “result”, which relates to the scores earned after having executed the game software; that is, the scores after each execution read by the game software.
C. Procedure of retrieving an object is activated if and when the result complies with the preset condition.
   If the scores earned after executing the game software in a certain play comply with the condition requiring that “the scores must be ranked at top five of the billboard” as defined, image input function is automatically activated by the game software and is further converted into photography model in conjunction with the mobile phone for the user to access to the photographic limits of authority in the game software.
D. The object retrieved is stored and have the object retrieved corresponding to the results availed in Step B.
   The user is authorized to take an image of a photo of him/herself as desired, and the photo is stored in a storage medium, e.g., a memory card, in the mobile phone; the photo is stored in digital records linked to the scores of the game software executed in the time of play that meets the preset condition.
E. When multiple result availed in Step B are present, the object retrieved is present accompanied by its corresponding result.
   Upon completing the execution of the game software each time, the screen on the mobile phone automatically displays the billboard of scores accumulated so far; wherein, the photos stored for each of those ranked at the top five will be displayed at the same time. Accordingly, other than the name or code, the photo of each of those ranked at the top five is synchronously displayed on the screen of the mobile phone while others ranked at the sixth place or under are present only in letters.

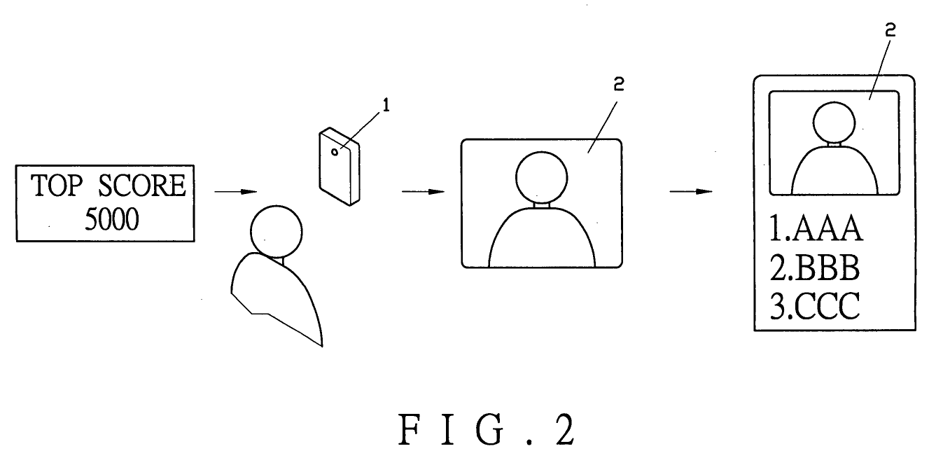

In practice as illustrated in FIG. 2, the present invention is physically executed in the following procedure:

1. The highest score is 5,000 points for the game software executed on a mobile phone (1).

2. The photography function of the mobile phone (1) is activated to execute the shooting for an image (2).

3. The image (2) is then stored in file.

4. The image (2) appears in the billboard of scores of the game software.

Furthermore, when the name ranked at the first place is selected (in reverse white), the screen simultaneously displays the photo taken by him/her; the photo taken by the one ranked at the second place simultaneously displays when the name of the one ranked at the second place is selected (in reverse white). The photo may be displayed with the name at the same time, or the name displays first followed by the image or the image displays first followed by the name.

In the preferred embodiment, the corresponding photo to the ranking may be present in an even special way to highlight the performance of the one ranked at the first place. For example, the image may be framed, given with special background, background applauds, or present in flares.

The object retrieved in Step C may be a stationary image, dynamic image or sound taped depending on the AV retrieval element adapted to the mobile phone.

Other than the mobile phone, a PDA, portable computer, or a game player may become the primary installation for the purpose of the present invention.

In another preferred embodiment of the present invention, the ranking method of student achievement reports is used for describing the present invention.
A. Set up condition.
   A server is installed with an achievement report statistical software with test scores and names of students inputted by a teacher; and in the present invention, the condition is preset as “the test scores must be 100” (in case of a 100-point system).
B. Perform a specific procedure to generate a result.
   A specific procedure is executed to the achievement statistics software that allows the teacher to enter test scores of each and all students; and a result generated relates to the scores of each student entered by the teacher and read out by the achievement statistics software.
C. Procedure of retrieving an object is activated if and when the result complies with the preset condition.
   If the test scores of a certain student entered by the teacher meet the preset condition that “the test scores must be 100”, the image input function of the achievement statistics software is automatically activated to permit the teacher to enter an image file of a “Written Citation of 100 Points”.
D. The object retrieved is stored and have the object retrieved corresponding to the results availed in Step B.
   The Written Citation of 100 Points image file is stored in a medium, e.g., a hard disk in the server; and the Written Citation of 100 Points relates to a digital record connected to the test scores of the student.
E. When multiple result availed in Step B are present, the object retrieved is present accompanied by its corresponding result.
   Upon completing the inputs of all test achievements, the monitor will automatically display the achievements of all the students in the same class when any student clicks on the statistical data of achievements of the class; meanwhile, the Written Citation of 100 Points will be displayed at the same time after the corresponding name of the student, and any other student failing to achieve 100 points will have his/her name displayed only in code or letters.

The method disclosed in the present invention may be written in programming language and executed in a portable power toy, PDA, computer game, or even a digital camera provided with a screen and capable of running programs. Therefore, any installation to execute the method of the present invention falls also within the teaching of the present invention.

Whereas the method disclosed in the present invention can be written in computer language and executed, a medium recording application to execute the method and that can be read by a computer is also included in the teaching of the present invention.

What is claimed is:

1. A method to incorporate specific numeric values sort with image retrieval and reproduction including the following steps:
A. set up condition;
B. perform a specific procedure to generate a result;
C. procedure of retrieving an object is activated if and when the result complies with the preset condition;
D. the object retrieved is stored and have the object retrieved corresponding to the results availed in Step B;
E. When multiple result availed in Step B are present, the object retrieved is present accompanied by its corresponding result.

2. The method to incorporate specific numeric values sort with image retrieval and reproduction of claim 1, wherein the object retrieved in Step C is a stationary image, dynamic image, or sound, or any combination between or among them.

3. The method to incorporate specific numeric values sort with image retrieval and reproduction of claim 1, wherein the object retrieved in Step C is present in its original form in Step E.

4. The method to incorporate specific numeric values sort with image retrieval and reproduction of claim 1, wherein the object retrieved in Step C is present not in its original form in Step E.

5. A mobile phone executes the method to incorporate specific numeric values sort with image retrieval and reproduction of claim 1.

6. A game device executing the method to incorporate specific numeric values sort with image retrieval and reproduction of claim 1.
